(19) United States
(12) Patent Application Publication
(10) Pub. No.: US 2016/0347584 A1
(43) Pub. Date: Dec. 1, 2016

(54) LIFTING ANCHOR WITH ENHANCED LOADBEARING FEATURES

(71) Applicant: Meadow Burke, LLC, Tampa, FL (US)

(72) Inventors: Michael J. Recker, Palmetto, FL (US); Ronald G. Naumann, Valrico, FL (US); Venkatesh Seshappa, Ames, IA (US)

(21) Appl. No.: 15/167,165

(22) Filed: May 27, 2016

Related U.S. Application Data
(60) Provisional application No. 62/168,299, filed on May 29, 2015.

(51) Int. Cl. B66C 1/66; E04G 21/14

(52) U.S. Cl. CPC B66C 1/666; E04G 21/142

(57) ABSTRACT

An improved lifting insert for provision within a concrete panel or other structural member is provided. The lifting insert comprises a base member, a lifting or contact member, and a plurality of members extending perpendicular to the base member to provide enhanced pull-out capacity for the insert. The lifting or contact member comprises a contact point for receiving a lifting device and for transferring force to a remainder of the insert.

This U.S. Non-Provisional Patent Application claims the benefit of priority from U.S. Provisional Patent Application Ser. No. 62/168,299, filed May 29, 2015, the entire disclosure of which is hereby incorporated by reference.

### FIELD

The present disclosure generally relates to lifting inserts for precast or preformed concrete panels. More specifically, the present disclosure relates to lifting inserts for embedment into a precast concrete structure and that comprise a lifting anchor and one or more support members for increasing a shear cone and related pull-out capacity of the insert.

### BACKGROUND

Prior art systems and devices for providing lifting anchors within precast concrete structures generally comprise dog-bone style anchors and related elongate anchor members for providing a connection and lifting interface between a concrete structure and a lifting device. Such devices, including those shown and described in U.S. Pat. No. 8,959,847 to Recker et al., which is hereby incorporated by reference in its entirety, fail to provide for various novel features of the present disclosure, including a base member with a plurality of members extending therefrom to increase lifting capacity and a related shear cone as shown an described herein. Known lifting anchors and devices, including those shown and described in U.S. Patent Application Publication No. 2004/0159069 to Hansort, which is hereby incorporated by reference in its entirety, contemplate a shear cone and pull-out capacity that is limited by the shape of the anchor. Known devices are generally characterized by small shear cones based on the provision of a single member extending into a concrete panel.

### SUMMARY

Accordingly, there has been a long-felt but unmet need to provide a lifting insert with increased capacity and increased pull-out strength. Embodiments of the present disclosure provide a lifting insert comprising a base member and a plurality of extensions extending from the base member, wherein at least one extension comprises a lifting interface for receiving a connecting member and transferring force to the insert and any associated structure in which the insert is provided.

In one embodiment, a lifting insert for embedment in a concrete component is provided, the lifting anchor comprising a base member having a first side and an opposing second side, a length, a width, and a thickness. The first side of the base member comprises a primary lifting member and at least one secondary support member, and the primary lifting member extends substantially perpendicular to the base member. The primary lifting member comprises a first length with a first end secured to the base member and a second end, the second end comprising at least one of a flange and a fillet adapted for communicating with a lifting device. The at least one second anchor member comprises a second length with a first end secured to the base member, and the first length is greater than the second length. In certain embodiments, the at least one secondary support member comprises four secondary support members geometrically arranged about the primary lifting member, and each of the secondary support members are spaced equidistant from the primary lifting member. In further embodiments, the second side of the base member comprises a planar portion devoid of any features or anchors extending therefrom. In preferred embodiments, the insert comprises a single die-cast component formed from at least one ferrous material, and preferably steel.

In one embodiment, a plurality of anchors or studs are provided extending from a connecting member or carrier that does not comprise a plate. Specifically, in various embodiments, the present disclosure contemplates providing a non-structural connecting member or carrier comprising at least one of a molded plastic strip and a metal strap. The connecting member comprises a plurality of studs or anchors extending therefrom. In one embodiment, the connecting member comprises a dog-bone anchor and a plurality of two-headed studs extending therefrom, wherein the dog-bone anchor member comprises a lifting element. The studs and/or anchors are secured to the connecting member by at least one of a snap-fit and a tack-weld. The connecting member extends between the studs and/or anchors to generally maintain a desired relative spacing and arrangement of the studs and/or anchors. In such embodiments, the base members or bottom heads of the studs comprise anchoring features, and the device is devoid of a base plate as provided in other embodiments.

In various embodiments of the present disclosure, lifting anchors are provided or embedded within a concrete structure. The concrete structure(s) may comprise, for example, wall panels, retaining walls, concrete conduit members, drainage and storage members, and any number of concrete or rock structures that may need to be moved or lifted.

In one embodiment, a lifting insert for embedment in a concrete component is provided, the lifting anchor comprising a base plate, a first side of the base plate comprising a primary lifting member and at least one secondary support member, the primary lifting member extending substantially perpendicular to the base plate. The primary lifting member comprises a first length with a first end secured to the base plate and a second end, the second end comprising at least one of a flange and a fillet adapted for communicating with a lifting device. The at least one secondary anchor member is secured to the base plate and comprises a second length that is different from the first length, the second length extending between a first end of the secondary anchor member and a second end, the second end comprising a free end. Each of the first end of the primary lifting member and the secondary anchor members are provided in the same plane. Each of the primary lifting member and the secondary anchor member are provided substantially perpendicular to the base plate, and the lifting insert is operable to provide an enhanced shear cone and reduce a risk that the lifting insert will be removed from a concrete component during a lifting operation. As used herein, the term “shear cone” generally refers to a cone shaped section of concrete or similar material that is or would be removed from a concrete structure when an item such as an anchor bolt or lifting insert is forcibly pulled from the concrete. One of skill in the art will recognize that the force required to pull out such a cone shaped section of concrete from a larger structure corresponds to the force required to separate the concrete or rock over a total surface area of the cone. Accordingly, larger volume cones correspond to greater pull-out strength and/or shear resistance strengths.

In one embodiment, a lifting insert for positioning and embedment in a concrete component is provided, the lifting anchor comprising a base member having a first side and an opposing second side, a length, a width, and a thickness. The first side of the base plate comprises a primary lifting member and at least one secondary support member, the primary lifting member extends substantially perpendicular to the base member. The primary lifting member comprises a first length with a first end secured to the base member and a second end, the second end comprising at least one of a flange and a fillet adapted for communicating with a lifting device. The at least one second anchor member is secured to the base member and comprises a second length that is different from the first length.

In one embodiment, a method of installing a lifting anchor in a precast concrete element is provided, the method comprising the steps of providing a lifting insert for embedment in a precast concrete element, the lifting anchor comprising a base member having a first side and an opposing second side, a length, a width, and a thickness, the first side of the base member comprising a primary lifting member and at least one secondary support member, the primary lifting member extending substantially perpendicular to the base member, the primary lifting member comprising a first length with a first end secured to the base member and a second end, the second end comprising at least one of a flange and a fillet adapted for communicating with a lifting device, and the at least one second anchor member secured to the base member and comprising a second length that is different from the first length; forming a precast concrete element, wherein at least a portion of the lifting insert is provided within the precast concrete element; and forming a void in the precast concrete element, wherein at least a portion of said primary lifting member extends into said void and wherein said at least one second anchor member and said base member are encased within the precast concrete element.

In various embodiments, lifting inserts of the present disclosure comprise base members. In certain embodiments, the base member(s) comprise substantially planar plate members with supports and/or lifting anchors extending substantially perpendicularly therefrom. In further embodiments, the base member(s) comprises a connecting member including (for example) a rail or extension. In additional embodiments, it is contemplated that the base member comprises a non-planar base member. For example, the base member may comprise a convex member, a concave member, and/or various geometric objects. In one alternative embodiment, for example, a base member comprises a spherical member with lifting members and/or anchors extending therefrom. The base member(s) may also comprise an irregularly shaped object to increase a surface area of the base member and thereby increase a contact area between the base member and a concrete to be provided in combination with the base member.

In various embodiments, lifting inserts are provided with a lifting interface or primary lifting anchor. Inserts of the present disclosure are also contemplated as comprising a plurality secondary supports that are spaced apart from the primary lifting anchor as shown and described herein. The secondary supports are provided to increase a surface area between the insert and a concrete member, and to provide enhanced anchorage of the insert within the member. The secondary supports preferably comprise heads or protrusions on one end, and the secondary supports are placed in tension during a lifting operation thereby disrupting the formation of a shear cone that would or may result without the secondary supports. The secondary supports create a larger shear cone that would be necessary to pull the insert out from the concrete and shear off a portion or cone of the concrete. The force required to remove the insert or pull-out strength is thereby increased over known devices.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a front perspective view of a lifting insert according to one embodiment of the present disclosure.

FIG. 2 is a side elevation view of the embodiment of FIG. 1 embedded within a concrete structure.

FIG. 3 is a top plan view of the embodiment of FIG. 1 embedded within a concrete structure.

FIG. 4 is a top plan view of a lifting insert according to another embodiment of the present disclosure.

FIG. 5 is a front elevation view of the lifting insert according to the embodiment of FIG. 4.

FIG. 6 is a side elevation view of a lifting insert according to another embodiment of the present disclosure.

FIG. 7 is a top plan view of the lifting insert according to the embodiment of FIG. 6.

FIG. 8 is a top plan view of a lifting insert according to another embodiment of the present disclosure.

FIG. 9 is a top plan view of a lifting insert according to another embodiment of the present disclosure.

FIG. 10 is a cross-sectional elevation view of a portion of the lifting insert according to FIG. 9.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

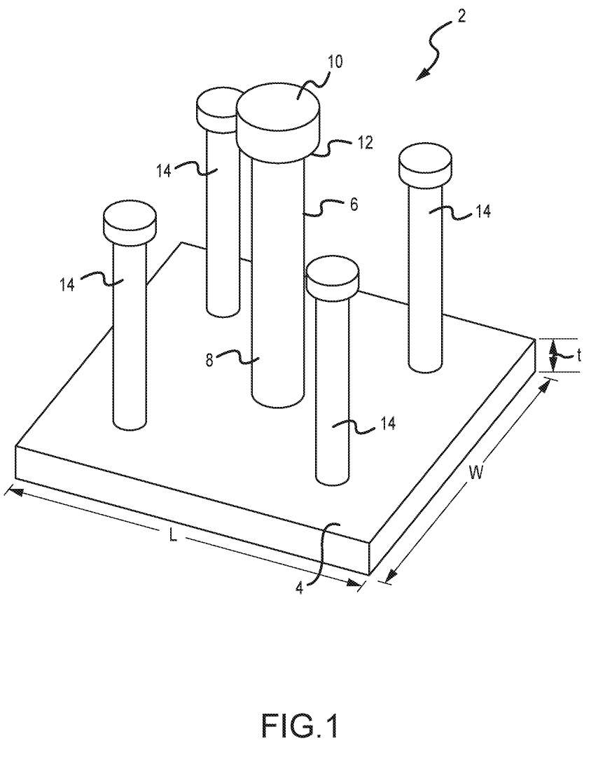

FIG. 1 is a front perspective view of a lifting insert 2 according to one embodiment of the present disclosure. As shown, the lifting insert 2 comprises a base plate 4 comprising a width W, a length L, and a thickness t. In the depicted embodiment, the base plate 4 comprises a substantially planar member. In alternative embodiments, a base plate 4 is provided with a curvilinear shape which may either be convex or concave. Additionally, although a preferred embodiment comprises a base plate 4 having a rectilinear shape (FIG. 1), alternative shapes are also contemplated. The base plate 4 may comprise rounded members including circular and oval shapes, and/or various irregular shapes. The shape of the base plate 4 may be varied based on numerous considerations, including the size of a related structure within which the insert 2 is to be embedded.

The base plate 4 of FIG. 1 comprises a primary lifting member 6 extending from a first side of the plate 4. The primary lifting member 6 comprising a lifting interface adapted for communicating with a lifting shackle or similar device as will be recognized by one of ordinary skill in the art. The primary lifting member 6 comprises a body portion 8 with a substantially circular cross section and a head 10 comprising a larger diameter than the body portion. The head 10 extends from the body portion 8 via a flange 12 or fillet. In certain embodiments, the primary lifting member 6 and the base plate 4 comprise a single element, but are described herein as different components for the sake of clarity. In alternative embodiments, the primary lifting member 6 is welded or otherwise secured to the base plate 4.

As also shown in FIG. 1, the insert 2 comprises a plurality of secondary supports 14. The secondary supports 14 comprise substantially perpendicular extensions of the plate 4 spaced apart from the primary lifting member 6. In preferred embodiments, the insert 2 comprises a single cast structure. Alternatively, the plate 4, primary lifting member 6 and the secondary supports 14 are welded together to form a single structure. The secondary support members 14 comprise reinforcing members that extend into a portion of a concrete member (or similar) when the insert 2 is cast in a desired position. The secondary supports 14 increase surface area contact with the structure in which the insert 2 is embedded and provide force transmitting members to increase the capacity and strength of the insert 2.

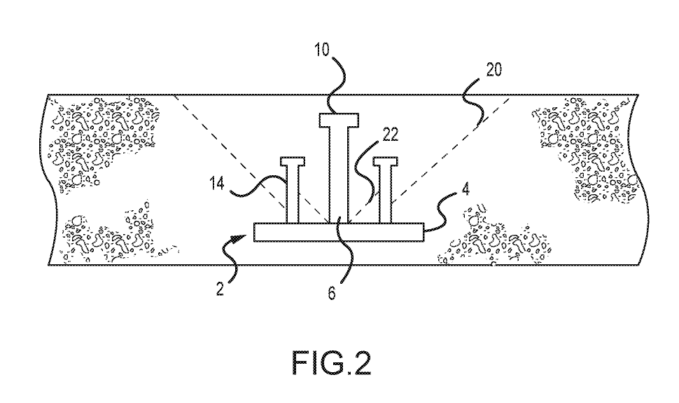

FIG. 2 is a side elevation view of a lifting insert 2 provided at least partially within a concrete structure 16. Lifting inserts 2 of the present disclosure are suitable for use with various concrete precast structures including, but not limited to, wall panels, columns, dividers, barriers, and similar features. For illustrative purposes, a shear cone 20 associated with preferred embodiments of the present invention is shown. For illustrative and comparison purposes, an alternative shear cone 22 associated with prior art devices is provided. The improved shear cone 20 of the present disclosure comprises a shear cone of increased volume, representing increased shear and pull-out capacity provided by the insert 2 of the present disclosure.

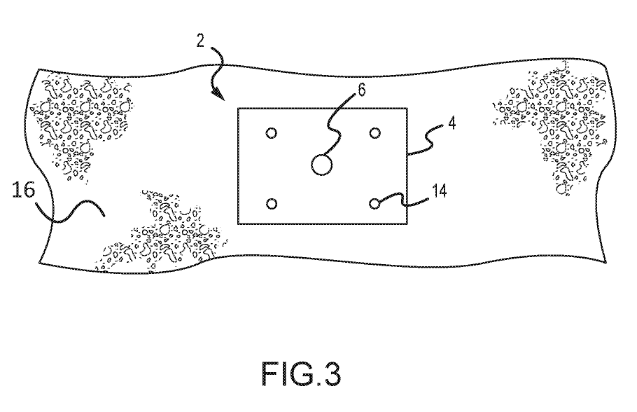

FIG. 3 is a top plan view of the insert 2 according to the embodiment of FIGS. 1 and 2. As shown, the insert 2 comprises a base plate 4, a primary lifting member 6, and a plurality of secondary supports 14. In various embodiments, the secondary supports 14 comprise members having a first cross-sectional shape or diameter along a first portion of the length of the member and a second cross-sectional shape or diameter along a second portion of the length of the member. In certain embodiments, the secondary support members 14 comprise rebar members extending substantially perpendicularly from the base plate 4.

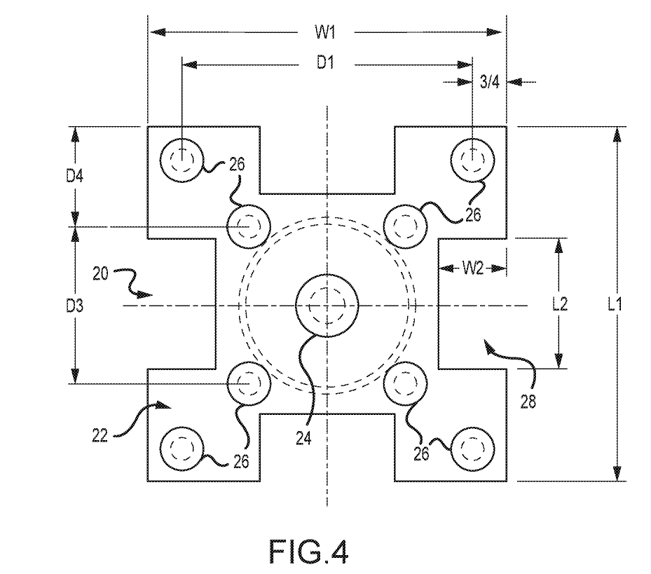

FIG. 4 is a top plan view of an insert 20 according to one embodiment of the present disclosure. As shown, the insert 20 comprises a base member 22 having a predetermined shape. A primary lifting member 24 is provided on the base member 22. A plurality of secondary supports 26 are provided on the base member 22 and distributed on the base member 22.

As shown in FIG. 4, the base member 22 comprises a generally symmetrical geometry when viewed from the top. The geometry of the base member 22 comprises a length L1. In various embodiments, the length L1 comprises the same magnitude as the overall width W1 of the insert and the insert thus comprises a square footprint with void spaces as shown and described. In certain embodiments, the length L1 is between approximately 5 and 10 inches. In preferred embodiments, the length L1 is approximately 8 inches. As further shown in FIG. 4, the insert 20 comprises a plurality of void spaces 28. The void spaces 28 comprise recesses, voids, or cut-outs in an otherwise solid plate 22. In the depicted embodiment, the void spaces 28 comprise rectilinear voids at or adjacent to each of the four edges of the base member 22. The void spaces 28 comprise a length L2 and a width W2. In various embodiments, the length L2 of the void spaces 28 is between approximately 1 and 5 inches, and preferably about 3 inches. In various embodiments, the width W2 of the void spaces 28 is between approximately 0.5 and 4 inches, and preferably approximately 1.5 inches. The void spaces 28 preferably comprise areas that are devoid of material, including the metal or other material that forms the base plate. In alternative embodiments, however, it is contemplated that the void spaces are simply areas where no supports are provided.

As shown in FIG. 4, a distribution of a primary lifting member 24 and a plurality of secondary supports 26 are provided. The secondary supports 26 are distributed in a substantially symmetrical manner around the primary lifting member 24. In the depicted embodiment, the secondary supports 26 are provided in a spaced apart manner. Specifically, and in the embodiment provided in FIG. 4, the centers of the secondary supports 26 are spaced apart at a distance D1 that is between approximately 5.0 and 10.0 inches, and preferably approximately 6.50 inches.

In the embodiment of FIG. 4, the void spaces 28 are provided to reduce the overall weight of the device 20. Alternative embodiments of the present disclosure contemplate providing a lifting insert 20 that is devoid of void spaces 28, as well as embodiments that comprise different arrangements of void spaces 28.

FIG. 4. depicts a particular embodiment wherein first and second secondary supports 26 are spaced apart by a first distance D3 and wherein the first distance D3 is between approximately 1.0 inches and approximately 5.0 inches, and is preferably approximately 3.5 inches. Outermost secondary supports 26 are spaced apart from the inner secondary supports by a second horizontal distance D4, wherein the second horizontal distance is between approximately 1.0 inches and approximately 3.0 inches, and is preferably approximately 2.25 inches.

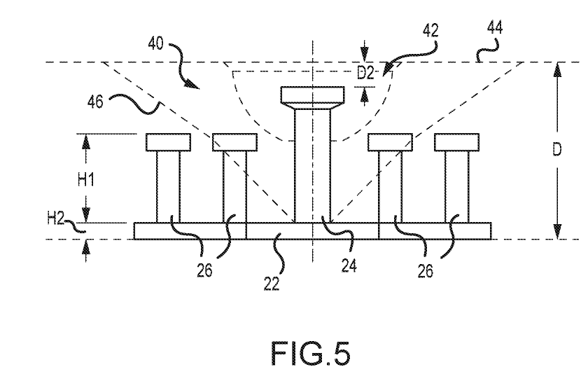

FIG. 5 is a side elevation view of the lifting insert 20 according to the embodiment of FIG. 4. The lifting insert 20 is shown relative to a concrete member 40. The concrete member comprises at least one void space 42 extending below an outer surface of the concrete member 40 as shown. The primary lifting member 24 extends at least partially into the void space 42 such that an upper portion or the head is exposed within the void space 42 and accessible for connection and lifting purposes, as one of ordinary skill in the art will recognize. The plurality of secondary supports 26 are distributed around the primary lifting member 24 are preferably embedded within the concrete member 40. An exemplary shear cone 46 is shown. The shear cone 46 represents a potential failure mode of the concrete member 40 when a lifting load exceeds a maximum tolerance. As shown, the shear cone 46 comprises a dimension that is smaller than the insert 20 and wherein at least the outer secondary supports 26 are encased within the concrete member 40 even after a pull out event or failure has occurred.

As shown in FIG. 5, the secondary supports 26 are contemplated as comprising a height H1 extending above the base member 22. In various embodiments, the height H1 is between approximately 1.0 and approximately 5.0 inches. In a preferred embodiment, the height H1 is approximately 2.0 inches. The base member 22 comprises a thickness or height H2 of between approximately 0.25 inches and approximately 2.0 inches, and preferably of approximately 0.34 inches.

FIG. 5 depicts one embodiment of the present disclosure installed or encased in a concrete structure 40, and wherein the base member 22 of the insert 20 is installed at a depth D below an outer surface 44 of the concrete member 40. The depth D as shown in FIG. 5 is preferably approximately 4.0 inches. Accordingly, an upper portion of the primary lifting member 24 is provided at a depth D2 below the outer surface 44 of the concrete member 40. The depth D2 is between approximately 0.25 inches and approximately 1.0 inches, and is preferably approximately 0.5625 inches. This depth D2 provides a flush outer surface of the concrete structure such that the primary lifting member 24 does not extend or protrude from the concrete member 40, while also rendering the primary lifting member 24 generally accessible to users and lifting equipment.

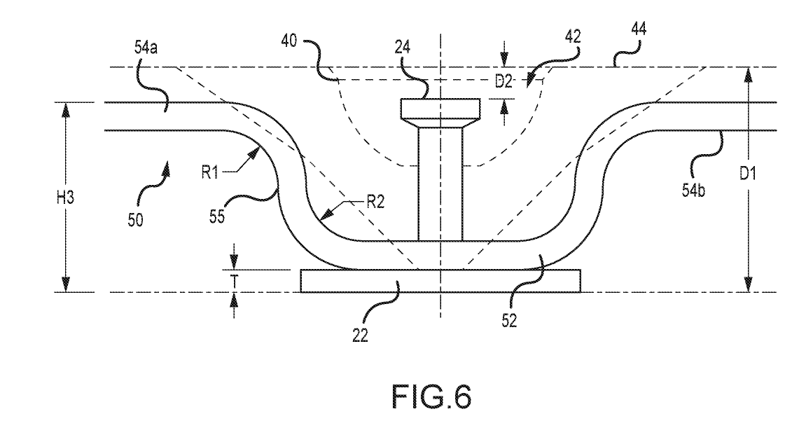

FIG. 6 is a side elevation view of a lifting insert 20 according to another embodiment of the present disclosure. As shown, the insert 20 comprises a base member 22 and a primary lifting member 24 extending therefrom. The lifting insert 20 is shown in combination with and at least partially embedded within a concrete member 40. The concrete member 40 comprises a void space 42 formed therein. The void space 42 extends into and comprises a void in an outer surface 44 of the concrete member 40. The lifting insert 20 of the embodiment shown in FIG. 6 comprises at least one secondary support in the form of an arcuate support member 50. The arcuate support member 50 is contemplated as comprising an elongate section of reinforcing bar (or “rebar”) that is bent or curved as shown in FIG. 6 (for example). The arcuate support 50 of FIG. 6 comprises at least one linear section 52 provided in connection with the base member 22 of the insert 20. The linear section 52 is secured to the base member 22 by various methods and devices as will be recognized by one of skill in the art. In various embodiments, the arcuate support member 50 is welded to the base member 22 to provide a secure connection between the base member 22 and the arcuate support member 50.

As shown in FIG. 6, a first linear section 52 of the arcuate reinforcement member 50 is provided in connection with the base member 22. The arcuate reinforcement member 50 extends upwardly to second and third linear sections 54a, 54b. A radius of curvature R1 is provided wherein the second linear section 54a is bent or curved with respect to a substantially vertical portion 55. The substantially vertical portion 55 extends into the first linear section 52 about a second radius R2, where R2 comprises approximately the same radius as R1 and wherein R2 is oriented in an opposite direction as R1. The second and third linear sections 54a, 54b comprise a height H3 as measured from a lower portion of the base member 22 to an upper portion of the linear sections 54a, 54b. The H3 is between approximately 2.0 and 5.0 inches, and is preferably approximately 3.375 inches. A thickness T of the base member 22 is between approximately 0.25 inches and approximately 1.0 inches, and is preferably approximately 0.375 inches. FIG. 6 depicts one embodiment of the present disclosure installed or encased in a concrete structure 40, and wherein the base member 22 of the insert 20 is installed at a depth D below an outer surface of the concrete member 40. The depth D as shown in FIG. 6 is preferably approximately 4.0 inches and more preferably of approximately 4.125 inches. Accordingly, an upper portion of the primary lifting member 24 is provided at a depth D2 below the outer surface 44 of the concrete member 40. The depth D2 is between approximately 0.25 inches and approximately 1.0 inches, and is preferably approximately 0.5625 inches. This depth D2 provides a flush outer surface of the concrete structure such that the primary lifting member 24 does not extend or protrude from the concrete member 40, while also rendering the primary lifting member 24 generally accessible to users and lifting equipment.

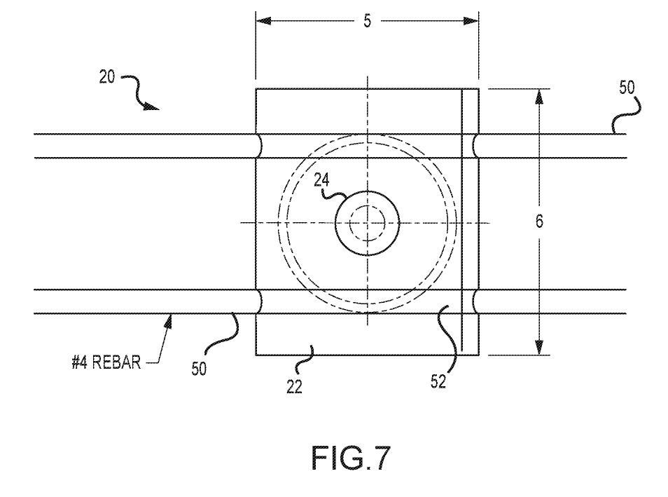

FIG. 7 is a top plan view of the insert 20 according to the embodiment of FIG. 6. As shown in FIG. 7, two arcuate support members 50 are provided, the arcuate support members 50 securely interconnected to the base member 22. In the embodiment of FIG. 7, the arcuate support members 50 are spaced apart on a base member 22, wherein the base plate comprises a rectangular base plate with a width of preferably approximately 5.0 inches and a length of approximately 6.0 inches. The arcuate support members 50 are spaced equidistant from a center of the insert 20, wherein a primary lifting member 24 is aligned with and extends from the center of the insert 20.

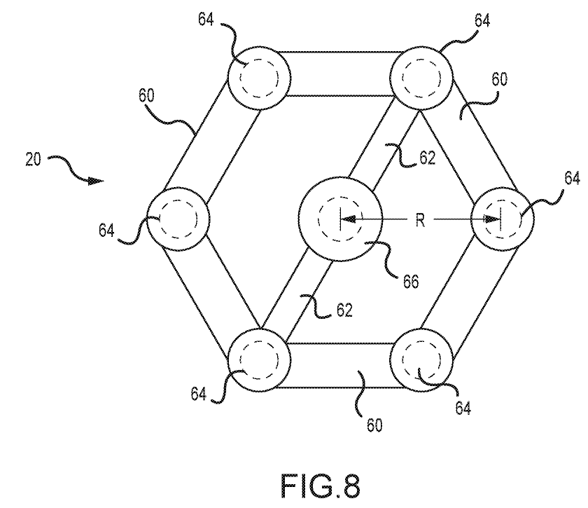

FIG. 8 is a top plan view of another embodiment of a lifting insert 20. The lifting insert 20 of FIG. 8 comprises a plurality of radially spaced secondary support members 64. The secondary support members 64 are spaced apart and are radially equidistant from a primary lifting member 66. The insert 20 comprises a rail member 60 that is generally provided as a hexagon. A secondary support member 64 is provided at each intersection of the sides of the hexagon. A diagonal support 62 is provided that extends across an internal area of the rail member 60. An anchor or primary lifting member 66 is provided on the diagonal support 62. Although not shown in FIG. 8, it is contemplated that the lifting insert 20 comprises a plurality of diagonal supports. In various alternative embodiments, it is contemplated that the insert 20 comprises two or more diagonal supports extending in the interior space formed by the rail member 60. In one embodiment, two diagonal supports extend within the interior space and form a “X” shaped pattern. In further embodiments, it is contemplated that the insert 20 comprises one or more supports that extend non-diagonally within the interior space formed by the rail member 60.

As provided in FIG. 8, each of the secondary supports 64 are preferably equidistant from a primary lifting member 66. More specifically, each of the secondary supports 64 in FIG. 8 are radially spaced from the primary lifting member 66 by a radius R that is between approximately 1.0 and 5.0 inches. In a preferred embodiment, the radius R comprises a distance of approximately 2.5 inches.

Although not shown in the top of FIG. 8, the secondary supports 64 comprise a height, and wherein each of the secondary supports 64 comprises substantially the same height. That height is preferably between approximately 1.0 and approximately 5.0 inches. The primary lifting member 66 comprises a second height, wherein the second height is greater than the height of the secondary supports 64 and is preferably between approximately 2.0 inches and approximately 5.0 inches, and preferably approximately 3.25 inches. The rail member 60 of the embodiment of FIG. 8 comprises a thickness that is between approximately 0.25 inches and approximately 2.0 inches.

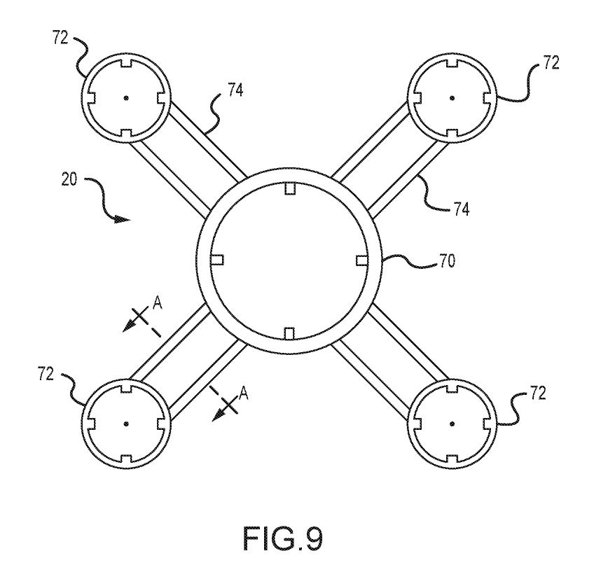

FIG. 9 is a top plan view of a lifting insert 20 according to another embodiment of the present disclosure. As shown, the lifting insert 20 comprises a primary lifting member 70 and a plurality of secondary support members 72 radially spaced around the primary lifting member 70. The lifting insert 20 comprises a plurality of extension arms 74 that extend outwardly from the primary lifting member 70. The secondary support members 72 are provided at distal ends of the extension arms 74 and extend upwardly therefrom. In preferred embodiments, the primary lifting member 70 comprises a first height extending above the extension arms 74 and wherein the extension arms 74 generally comprise a base of the insert 20. The secondary support members 72 comprise a second height extending above the extension arms 74, wherein the second height is preferably smaller than the first height. Preferably, each of the secondary support members 72 comprise the same height as the other secondary support members 72. In alternative embodiments, it is contemplated that the secondary support members comprise a plurality of different heights.

Although not shown in the top of FIG. 9, the secondary supports 72 comprise a height, and wherein each of the secondary supports 72 comprises substantially the same height. That height is preferably between approximately 1.0 and approximately 5.0 inches. The primary lifting member 70 comprises a second height, wherein the second height is greater than the height of the secondary supports 64 and is preferably between approximately 2.0 inches and approximately 5.0 inches, and preferably approximately 3.25 inches. The rail member 60 of the embodiment of FIG. 8 comprises a thickness that is between approximately 0.25 inches and approximately 2.0 inches.

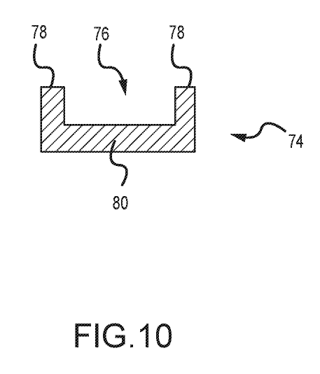

FIG. 10 is a cross-sectional elevation view taken at point A as shown in FIG. 9. As shown in FIG. 10, an extension arm 74 of the lifting insert 20 comprises a cross-sectional shape. As shown in FIG. 10, the extension arm 74 comprises a cross-sectional profile comprising a trough 76 provided between upstanding sidewalls 78 and a base portion 80.

Although various dimensions and proportions of lifting inserts contemplated by the present disclosure are provided herewith, it will be expressly recognized that the various dimensions provided are for illustrative purposes only. Various alternative dimensions are within the scope of the present disclosure, and the lifting anchors shown and described herein should not be deemed to be limited to one or more disclosed dimensions. The lifting anchors of the present disclosure may be scaled up or down to render them useful for lifting larger or smaller objects. Additionally, the proportions of the lifting anchors may be altered. For example, it is contemplated that the heights of the primary lifting members and/or secondary supports shown and described herein may be lengthened or shortened without similar altering the size of a base member upon which such features are provided.

In various embodiments, a method of inserting or forming at least one lifting insert within a portion of a precast concrete member is provided. U.S. Patent Application Publication No. 2002/0195537 to Kelly et al., which is hereby incorporated by reference in its entirety, discloses methods and systems for forming or inserting anchors within concrete members. Similar methods and devices and variants thereof are contemplated as within the scope of the present disclosure.

In one embodiment, a method of embedding a lifting anchor in a concrete structure is provided, the method comprising the steps of providing a polymeric hollow body having a first and second sections hinged together at their upper portions for movement between a closed condition engageable around an anchor received therebetween and an open condition in which the sections are separated to release an anchor received therebetween. The sections define a passage therebetween for receipt and retention of a lifting anchor and are provided with a latch to selectively secure the sections together. In the method, the sections are moved apart to receive the anchor and then moved together to secure the anchor in place. As so conditioned, the void former is cast in place within a concrete structure and, ultimately, removed from the structure by spreading the first and second sections apart and releasing them from the anchor. The lifting anchors for use with various methods of the present disclosure include lifting inserts as shown and described herein.

While various embodiments have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

What is claimed is:

1. A lifting insert for embedment in a concrete component, the lifting insert comprising:
a base plate;
a first side of the base plate comprising a primary lifting member and at least one secondary support member, the primary lifting member extending substantially perpendicular to the base plate;
the primary lifting member comprising a first length with a first end secured to the base plate and a second end, the second end comprising at least one of a flange and a fillet adapted for communicating with a lifting device;
the at least one secondary support member secured to the base plate and comprising a second length that is different from the first length, the second length extending between a first end of the secondary support member and a second end, the second end comprising a free end;
wherein each of the first ends of the primary lifting member and the secondary support members are provided in the same plane;
wherein each of the primary lifting member and the secondary support member are provided substantially perpendicular to the base plate; and
wherein the lifting insert is operable to provide an enhanced shear cone and reduce a risk that the lifting insert will be detached from a concrete component during a lifting operation.

2. The lifting insert of claim 1, further comprising at least two secondary support members.

3. The lifting insert of claim 2, wherein the at least two secondary support members are spaced radially equidistant from the primary lifting member.

4. The lifting insert of claim 2, wherein at least one of the secondary support members comprises an arcuate member.

5. The lifting insert of claim 1, wherein said plane extends along a surface of the base plate.

6. The lifting insert of claim 1, wherein the lifting insert comprises a ferrous material.

7. The lifting insert of claim 1, wherein the base plate comprises at least one of a void and an aperture extending through the base plate.

8. A lifting insert for embedment in a concrete component, the lifting insert comprising:
a base member having a first side and an opposing second side, a length, a width, and a thickness;
the first side of the base member comprising a primary lifting member and at least one secondary support member, the primary lifting member extending substantially perpendicular to the base member;
the primary lifting member comprising a first length with a first end secured to the base member and a second end, the second end comprising at least one of a flange and a fillet adapted for communicating with a lifting device; and
the at least one second support member secured to the base member and comprising a second length that is different from the first length.

9. The lifting insert of claim 8, wherein the at least one secondary support member comprises four secondary support members geometrically arranged about the primary lifting member, and wherein each of the secondary support members are spaced equidistant from the primary lifting member.

10. The lifting insert of claim 8, wherein second side of the base member comprises a planar portion devoid of any features or anchors extending therefrom.

11. The lifting insert of claim 8, wherein the lifting insert comprises a single die-cast component.

12. The lifting insert of claim 8, wherein the lifting insert comprises a ferrous material.

13. The lifting insert of claim 8, wherein the base member comprises at least one void space to reduce a weight of the lifting insert.

14. A method of installing a lifting insert in a precast concrete element, the method comprising the steps of:
providing a lifting insert for embedment in a precast concrete element, the lifting insert comprising a base member having a first side, the first side of the base member comprising a primary lifting member and at least one secondary support member, the primary lifting member extending substantially perpendicular to the base member, the primary lifting member comprising a first length with a first end secured to the base member and a second end, the second end comprising at least one of a flange and a fillet adapted for communicating with a lifting device, and the at least one secondary support member secured to the base member and comprising a second length that is different from the first length;
forming a precast concrete element, wherein at least a portion of the lifting insert is provided within the precast concrete element;
forming a void in the precast concrete element, wherein at least a portion of said primary lifting member extends into said void and wherein said at least one second support member and said base member are encased within the precast concrete element.

15. The method of claim 14, wherein said void is formed by a removable void former.

16. The method of claim 14, further comprising the steps of:
attaching a lifting member to said portion of said primary lifting member that extends into said void; and
performing a lifting operation wherein the precast concrete element is lifted by applying a force to said lifting member.

17. The method of claim 15, wherein the removable void former is provided around at least a portion of the primary lifting member.

18. The method of claim 14, wherein at least one end of said secondary support members comprise at least one of a flange, a fillet, and a head.

19. The method of claim 14, wherein a plurality of lifting inserts for embedment in a concrete component are provided.

20. The method of claim 14, wherein said base member comprises a substantially planar plate.
